(19) United States
(12) Patent Application Publication
(10) Pub. No.: US 2012/0141244 A1
(43) Pub. Date: Jun. 7, 2012

(54) Feeding Unit for an Inserting System

(75) Inventor: Wilhelm Markgraf, Schramberg/Tennenbronn (DE)

(73) Assignee: Mathias Baeuerle GmbH, St. Georgen (DE)

(21) Appl. No.: 13/311,653

(22) Filed: Dec. 6, 2011

(30) Foreign Application Priority Data
Dec. 6, 2010 (DE) 10 2010 054 389.6

(51) Int. Cl. B65G 37/00; B65G 59/00

(52) U.S. Cl. 414/798.9

(57) ABSTRACT

A feeding unit for an inserting system has a transport device and at least one stack support for a product stack from which products are individually and in sequence removed from an end face of the stack in a downward direction and transported father by the transport device. At least one support roller is positioned at the end face of the stack in an area above the transport device and adjustable in a direction transverse to the end face of the stack and in a direction of height of the end face of the stack.

### BACKGROUND OF THE INVENTION

The invention relates to a feeding unit for an inserting system comprising at least one stack support for a product stack, wherein the products are individually removed in sequence from the front of the stack in downward direction and are transported farther by means of a transport device.

In inserting systems, it is often necessary to stack paper sheets and the like in upright position before they are transported farther for further processing. These sheets are individually removed from the end face of the stack in downward direction and transported farther by means of the transport device. As long as the paper sheets have sufficient stability and stiffness, the paper sheets can be reliably removed sequentially from the end face of the stack. However, when the paper sheets have insufficient stiffness, there is the problem that they slide uncontrollably away from the end face of the stack and thereby impair further processing of the sheets in the inserting system.

### SUMMARY OF THE INVENTION

It is an object of the present invention to configure the feeding unit of the aforementioned kind in such a way that it enables removal of products of different stability reliably and individually in sequence from the end face of the product stack.

In accordance with the present invention, this is achieved in that the feeding unit comprises at least one support roller that is resting against the end face of the stack in the area above the transport device and is adjustable in a direction transverse to the end face of the stack as well as in a direction of height of the end face of the stack.

By means of the support roller of the feeding unit according to the invention, the products that are located at the end face of the stack can be secured optimally so that they do not slide uncontrolled in the direction toward the transport device. Depending on the properties of the product, the support roller can be positioned at a suitable location on the end face of the stack. With the feeding unit according to the invention, it is therefore possible to not only remove products that are stiff and maintain their shape but also unstable ones that cannot maintain their shape, for example, paper sheets, in a controlled fashion sequentially from the end face of the stack and to feed them to the transport devices. Since this support roller can be adjusted in a direction transverse to the end face of the stack as well as in the direction of height of the end face of the stack, an optimal position of the support roller on the stack end face can be determined in a simple way.

The support roller is advantageously adjustable along at least one carrier in the direction of height of the end face of the stack. On the carrier, the support roller can be reliably supported.

The carrier has advantageously at least one guide along which a carrier element of the support roller can be adjusted. Due to the guide the support roller can be adjusted precisely at the desired position of height.

In a preferred embodiment, the guide is a slot through which the carrier element of the support roller projects with a guide section. On it, an operating element is seated with which the carrier element can be clamped in a selected height position. Such an operating element can be e.g. a nut that is screwed onto a guide section in the form of a threaded pin. By means of the nut, the clamping action can be very easily and quickly released and also effected again.

Instead of such a manual adjustment of the support roller, it is also possible to adjust the support roller by a motor. The user can then move the support roller very simply into the required position.

The carrier is advantageously adjustable in a direction transverse to the end face of the stack so that the carrier can be adjusted optimally relative to the end face of the stack.

Such an adjustment can be achieved advantageously in that the carrier is arranged in the feeding unit in such a way that it is pivotable transversely to the stack end face.

For this purpose, advantageously an actuator shaft is provided to which the carrier is attached. The actuator shaft can advantageously be clamped by means of an actuating element in the desired rotational position. For rotating the actuator shaft, the clamping action is first released by means of the actuating element. After its rotation into the new position, the actuator shaft is then secured again by clamping by means of the actuating element.

The actuator shaft can also be rotated by means of a motor. In this case, an actuating element for clamping the actuator shaft is not required.

The carrier is advantageously plate-shaped.

Advantageously, the carrier is seated with its lower edge on the actuator shaft. It can be fixedly secured thereto in any suitable way. By rotation of the actuator shaft, the carrier is then pivoted into the required position relative to the product stack.

In order for the products to be removed reliably from the end face of the stack independent of the properties or condition of the individual products, the gap width of the individualizing gap can be advantageously adjusted. In this way, in interaction with the adjustment of the support roller, it is ensured that products of rather different properties can be reliably individualized and transported farther. The products may be paper sheets with minimal or high stiffness, plastic sheets, cardboard or carton, and the like. Such products can be, for example, brochures or flyers, account statements, and the like which are to be inserted into envelopes in an inserting system.

It is particularly advantageous when the support roller and the actuator shaft are adjusted by a motor, in particular in automated fashion. The operator can then save the optimal adjustment data of the support roller and of the actuator shaft and recall such data for adjustment when needed.

Further features of the invention result from the further claims, the description, and the drawings.

### BRIEF DESCRIPTION OF THE DRAWING

The invention will be explained in more detail with the aid of an embodiment illustrated in the drawings.

FIG. 1 shows the feeding unit according to the invention for an inserting system in a perspective illustration.

FIG. 2 shows in an illustration in accordance with FIG. 1 the feeding unit that contains a product stack.

FIG. 3 shows the feeding unit according to the invention with product stack in a different perspective illustration.

FIG. 4 is a side view of a part of the feeding unit according to the invention with a product stack that is comprised of relatively stiff, uniform products.

FIG. 5 shows the feeding unit according to the invention with a stack that is comprised of small stable upright products.

FIG. 6 shows the feeding unit according to the invention with a stack in which the lower edge of the individual products is thicker than the upper edge.

FIG. 7 shows in an illustration in accordance with FIG. 6 another position of support rollers which support the stack near the upper edge.

FIG. 8 shows the feeding unit according to the invention with a stack whose products have an upper edge and a lower edge with greater thickness than the remainder wherein the support rollers are resting near the upper edge of the products on the stack.

FIG. 9 shows in an illustration in accordance with FIG. 8 the feeding unit where the support rollers have a different position compared to the position shown in FIG. 8.

FIG. 10 shows in an illustration in accordance with FIG. 8 a further position of the support rollers on the stack.

FIG. 11 shows the feeding unit according to the invention with a stack whose products have a reinforced lower edge; the support rollers are resting near the upper edge of the products on the stack.

FIG. 12 shows the feeding unit according to FIG. 11 with a different position of the support rollers compared to the position of FIG. 10.

### DESCRIPTION OF THE PREFERRED EMBODIMENTS

The feeding unit is provided for an inserting system and serves for supplying brochures or inserts that are to be inserted into envelopes during further processing.

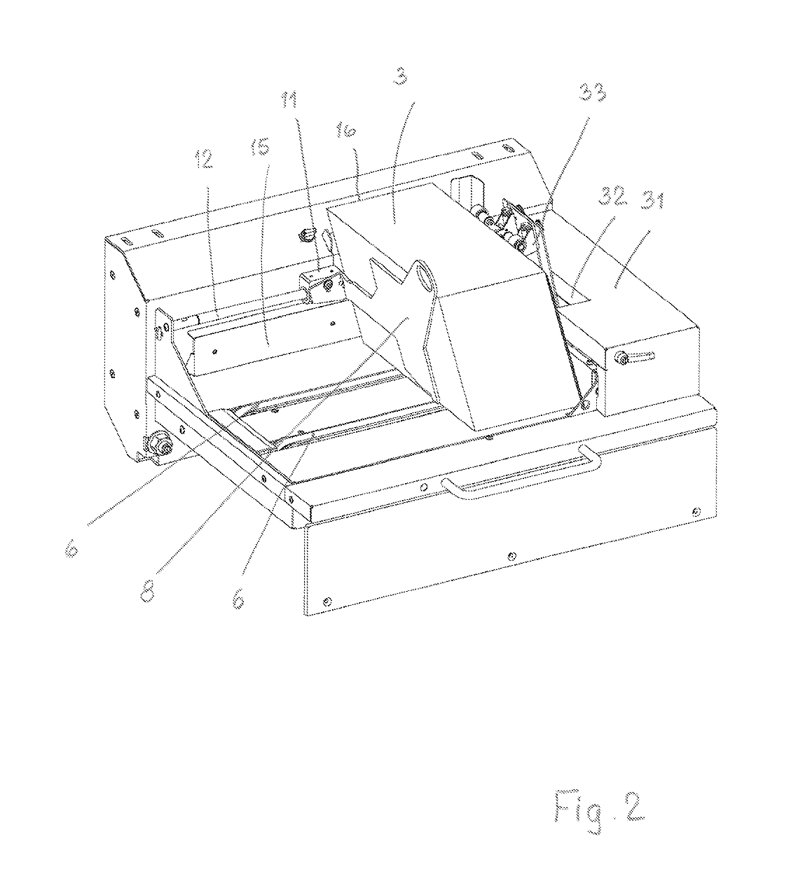

The feeding unit has a frame 1 with an upper support 2 on which a product stack 3 (FIG. 2) is resting. The support 2 has openings 4 that extends in longitudinal direction in which a drive 5 for the product stack is located. The drive 5 is comprised advantageously of two transport belts 6 that are positioned parallel to each other and that project slightly upward past the topside of the support 2. Between the two transport belts 6 there is a further support 7 whose topside is aligned with, or flush with, the topside of the support 2. The openings 4 that allow the transport belts 6 to project upwardly through the supports 2, 7 are only slightly wider than the transport belts 6. In this way, it is achieved that the product stack 3 during its transport is supported on a large surface area on the supports 2, 7.

In order to support the product stack 3 rearwardly, a rear stack support 8 is provided that advantageously is formed by a sheet metal part. The stack support 8 has a transversely projecting arm 9 whose free end 10 is angled and is attached to a block 11. The block 11 is slidable on a guide 12 that, in an exemplary embodiment, is formed by a round rod. The guide 12 is positioned parallel to the transport direction of the transport belts 6. In this way, the stack support 8 can be reliably moved in the transport direction. The guide 12 is positioned at a spacing above the supports 2, 7 and laterally adjacent to the product stack 3 (FIG. 2).

The arm 9 of the stack support 8 passes into a wide section 13 which forms a large surface area for supporting the product stack. The stack support 8 has a section 14 that extends down to the support 7 between the two transport belts 6. Advantageously, the width of the section 14 corresponds to the width of the support 7. Since the section 14 extends to a point close to the support 7, a product stack 3 is supported optimally at its rear. With a projecting nose 14′, the stack support 8 is positively or form fittingly connected to one of the transport belts 6. The stack support 8 is therefore reliably entrained when the product stack 3 is displaced or moved in transport direction upon removal of the products from its end face.

For laterally guiding the product stack 3, a guide surface 15 is provided which is located in the area below the guide 12 and extends parallel to the transport direction of the transport belts 6. The guide surface 15 extends upwardly from the support 2 and ends at a minimal spacing below the guide 12. The product stack 3 is resting with its left side (FIG. 2), viewed in the transport direction, on the guide surface 15. The guide surface 15 is advantageously a part of a stack guiding sheet metal that is attached to a side wall of the frame 1.

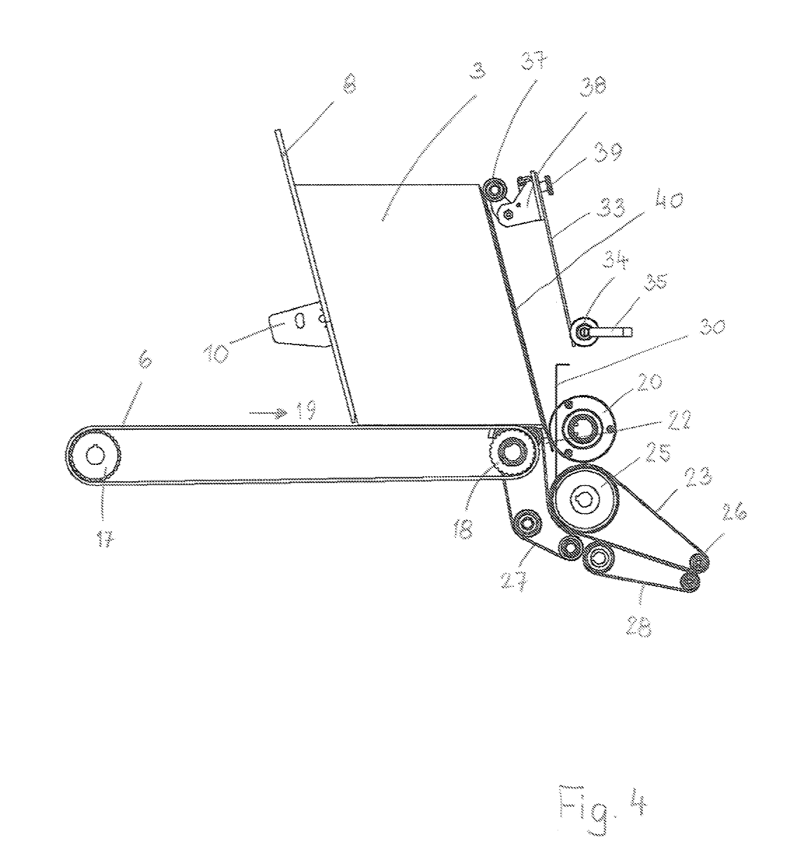

The transport belts 6 are guided about two drive pulleys 17, 18 (FIG. 4) that are advantageously embodied as gear rollers whose teeth engage a toothing on the inside of the transport belts 6. Because of this positive or form-fit meshing action, the transport belts 6 are driven free of slip. The drive rollers 17, 18 are advantageously provided for both transport belts 6.

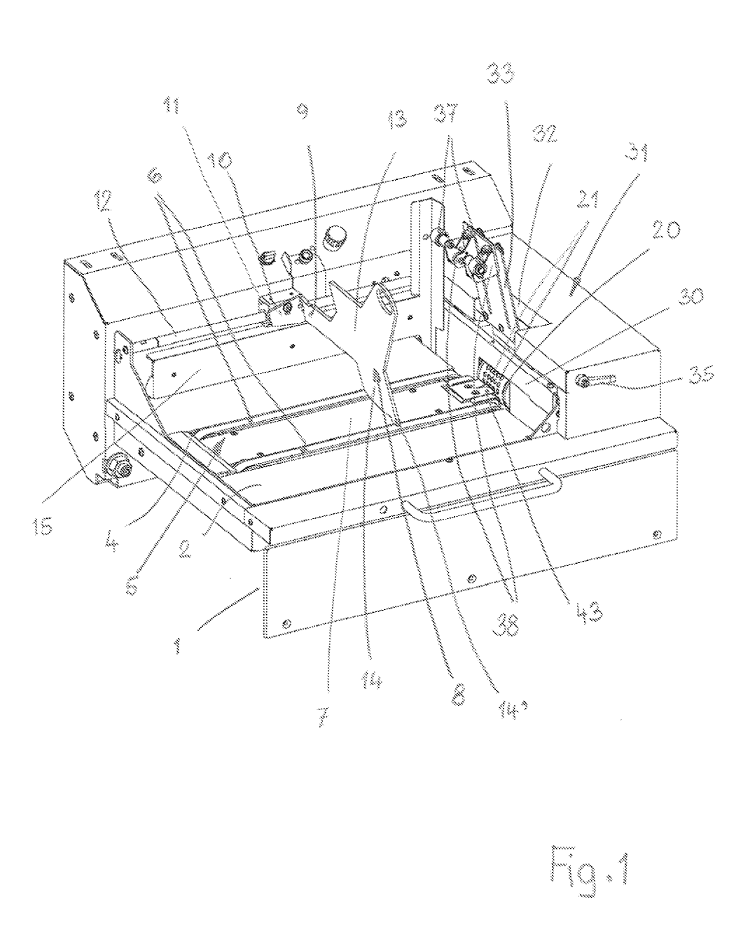

On the forward end in the transport direction 19 of the transport belts 6, there is a vacuum roller 20 having a wall with openings 21 (FIG. 1). As is known to a person of skill in the art, the vacuum roller 20 is connected to a vacuum source. Through the openings 21 the vacuum is applied onto the products to be removed from the stack 3.

The vacuum roller 20 is positioned opposite an individualizing device 43 that is arranged between the two transport belts 6. The individualizing device 43 can be adjusted in the direction toward the vacuum roller 20 in order to adjust the width of the individualizing gap 22, provided between the individualizing device 43 and the vacuum roller 20, to the product thickness.

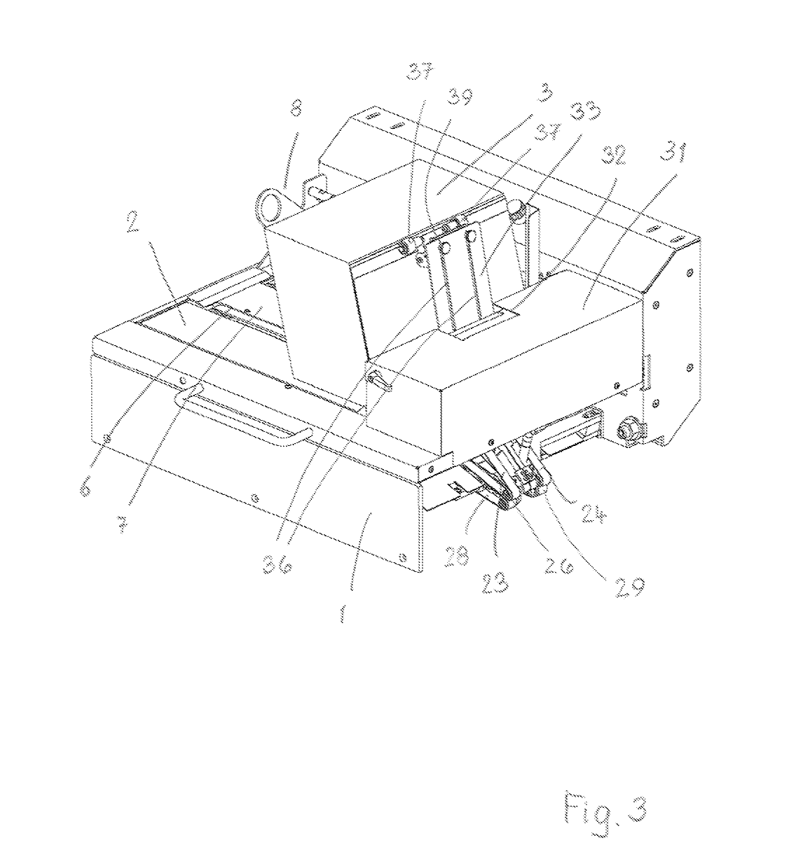

In the area below the vacuum roller 20 there are two circulating transport belts 23, 24 (FIG. 3 and FIG. 4) that are positioned at a spacing adjacent to each other and guided about two pulleys 25, 26. The two transport belts 23, 24 are advantageously provided with a common pulley 25, 26. The pulley 25 is positioned at a minimal spacing below the vacuum roller 20 (FIG. 4) while the pulley 26 is arranged outside of the feeding unit.

The transport belts 23, 24 are aligned in transport direction with the transport belts 6 and interact with transport belts 27, 28, 29 (FIG. 3 and FIG. 4) that, in turn, are aligned with the transport belts 6 or 23, 24 in the transport direction. The products removed from the product stack 3 are moved between the transport belts 23, 24 and 27, 28, 29 and are transported by the belts 23, 24, 27, 28, 29 away from the feeding unit.

The vacuum roller 20 projects through a forward stop 30 (FIGS. 1 and 4). The stop 30 is located at a side of the housing 31 that is facing the transport belts 6. The housing 31 has at its front side a cutout 32. Through the cutout 32 a plate-shaped carrier 33 projects outwardly. The carrier 33 is connected to an actuator shaft 34 (FIG. 4) that is supported rotatably in the housing 31. The actuator shaft 34 can be rotated by means of an actuating element 35 (see FIG. 1) about its axis and can be clamped in the desired rotational position. The actuating element 35 is easily accessible at the exterior of the housing 31.

The carrier 33 extends upwardly and has at least one, preferably two parallel extending, guides 36 (FIG. 3) along which support rollers 37 can be adjusted that are supported on carrier elements 38 so as to rotate freely. The carrier elements 38 project with a guide section in the form of a threaded pin through the slot-shaped guides 36. On the threaded pin there are operating elements in the form of nuts 39 with which the carrier elements 38 can be secured by clamping at the desired height of the carrier 33. In this way, the support rollers 37 can be adjusted for support of the product stack 3 at a suitable level in the direction of height of the carrier 33.

For the support rollers 37 a single carrier element 38 is sufficient. It can be provided with two threaded pins when the carrier 33 has two slot-shaped guides 36. When the carrier 33 has only a single slot-shaped guide 36, the common carrier element is provided with only one threaded pin. A rotation of the carrier element about the axis of the threaded pins is prevented by appropriate stops on the carrier 33 and/or on the carrier element.

The support rollers 37 can thus be adjusted by movement along the carrier 33 as well as by rotation of the carrier 33 by means of the actuator shaft 34 to different configurations of the product stack 3.

Instead of the nuts 39 also other operating elements can be used with which the support rollers 37 can be arrested at the desired height position.

FIG. 4 shows a product stack 3 comprised of shape-stable stiff products 40 that have a quadrangular contour and are in the form of sheets. In FIG. 4, the product 40 at the leading end is shown thicker in order to illustrate the removal process by means of the individualizing gap 22. By means of the transport belts 6 the entire product stack 3 is transported in transport direction 19. The leading product 40 is removed in the area between the vacuum roller 20 and the transport belt 27. The vacuum that is supplied by the vacuum roller 20 onto the leading product 40 pulls this product 40 into the individualizing gap 22. The lower product edge reaches thus the space between the transport belts 27 and 23, 24 so that the product 40 is removed in downward direction. Subsequently, it passes into the area between the transport belts 23, 24 as well as 28, 29 that transport the product 40 out of the feeding unit. In this way, the products are individually removed in sequence from the stack 3 that, in accordance with the product removal, is advanced by means of the transport belts 6. The rotationally driven vacuum roller 20 ensures a proper removal of the leading product 40 from the product stack 3.

Since the products 40 have a relatively high inherent stiffness, the stack 3 can be arranged so as to be slanted to the rear. In this case, the rear stack support 8 is slanted in a direction opposite to the transport direction 19. In this way, also the opposite leading side of the product stack 3 is arranged accordingly so that the removal of the products 40 is facilitated. The carrier 33 is also slanted opposite to the transport direction 19. The support rollers 37 are located near the upper product edge and support the stack 3 and the leading product 40 reliably. Since the support rollers 37 are free to rotate, the removal of the products 40 by means of individualizing gap 22 is not impaired.

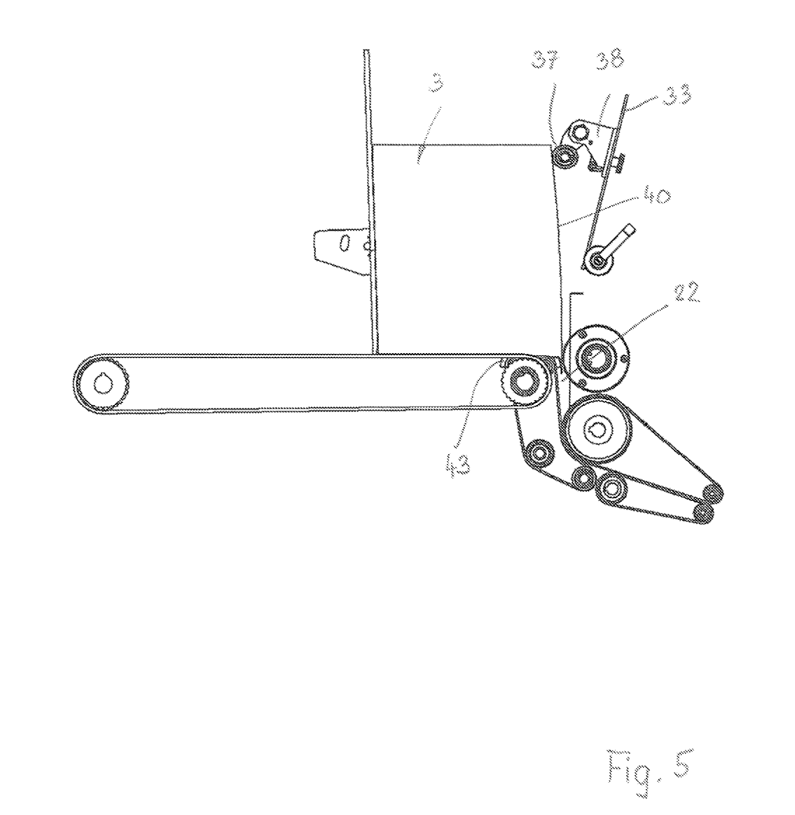

FIG. 5 shows a product stack 3 which is comprised of products 40 that, in comparison to FIG. 4, are smaller. They are also in the form of relatively stiff sheet-like objects that can stably stand upright and in this way ensure that the leading product 40 assumes the position required for insertion into the individualizing gap 22. The products 40 are however smaller than the products according to FIG. 4. Accordingly, the support rollers 37 are moved by means of the carrier elements 38 along the carrier 33 so far down in downward direction that the support rollers 37 are positioned near the upper edge on the stack 3.

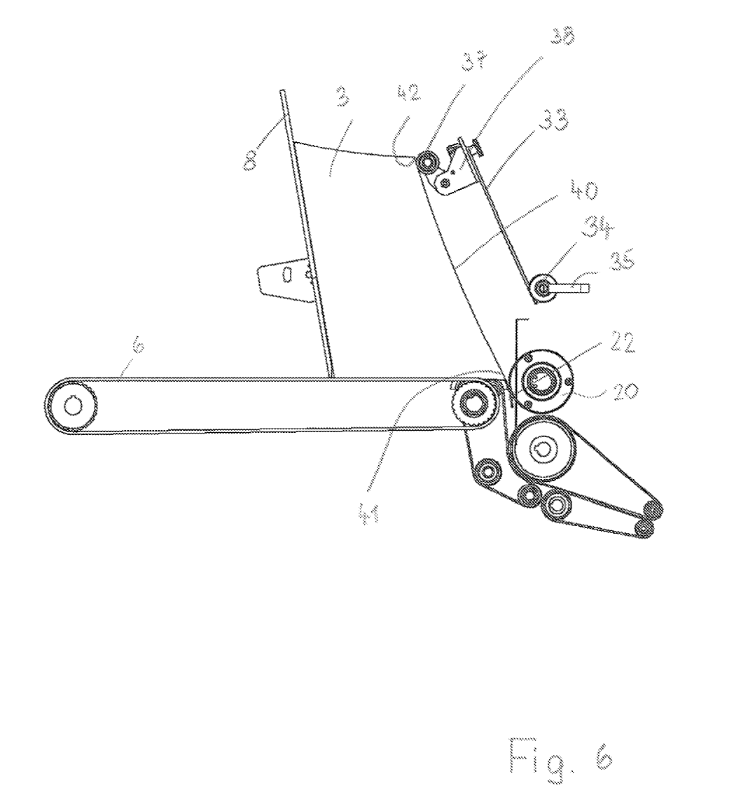

FIG. 6 shows a product stack 3 with products 40 whose lower edge 41 is thicker than the upper product edge 42. This causes the product stack 3 to be thinner in the upper area than in the lower area. This uneven thickness at the upper and lower product edges can be caused, for example, by the product 40 being folded at the lower product edge 41 or by staples located in this area or a print applied on one side of the product that makes the product thicker.

As a result of the uneven thickness of the stack 3 the leading product 40 assumes such a slanted position that normally the leading product 40 would slide in an uncontrolled fashion into the individualizing gap 22. This would mean that disturbances of the further processing steps could not be prevented.

By means of the feeding unit it is now possible to secure even these kinds of product stacks 3 properly such that the products 40 are conveyed in a controlled fashion into the individualizing gap 22. For this purpose, the carrier 33 is pivoted against the stack 3. The clamping action of the actuator shaft 34 is released by the actuating element 35 so that the actuator shaft 34 and thus the carrier 33 can be pivoted against the stack 3. The support rollers 37 are adjusted by means of the carrier elements 38 along the guides of the carrier 33 such that the support rollers 37 are positioned so as to rest against the upper edge of the stack 3.

The carrier 33 is pivoted against the stack 3 to such an extent that the support rollers 37 are resting with pressure application on the upper edge of the stack 3. In this position the actuator shaft 34 is clamped by means of the actuating element 35. The pressure is so great that the leading product 40 cannot slide downwardly into the individualizing gap 22 but can still be reliably removed by means of the vacuum roller 20 from the stack 3. By means of the vacuum roller 20 the products 40 are removed in a controlled fashion in sequence from the front side of the stack 3 and are then transported away from the feeding unit in the described way. In accordance with the product removal from the stack 3, the stack support stop 8 with the stack 3 is advanced by means of the transport belts 6 in the described way.

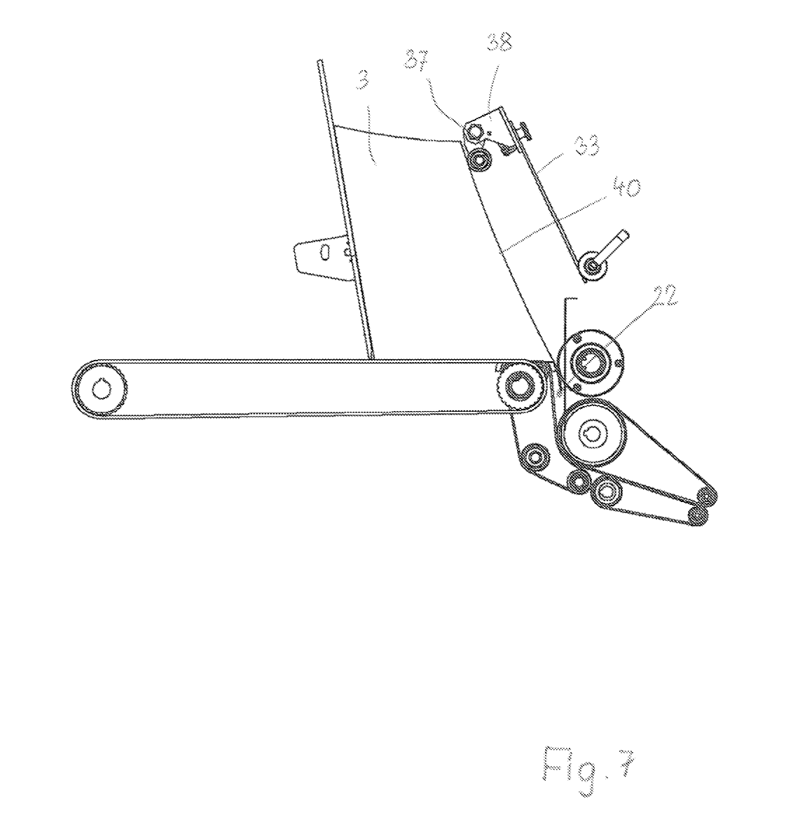

FIG. 7 shows that the carrier element 38 for the support rollers 37 can also be provided in a position rotated by 180 degrees on the carrier 33. In this case, the support rollers 37 are resting in the area below the carrier element 38, as is the case also in the embodiment of FIG. 5. The support rollers 37 are positioned in the embodiment according to FIG. 7 also near the upper edge of the product stack on the leading product 40 and prevented in this way that the products will slide in an uncontrolled fashion into the individualizing gap 22.

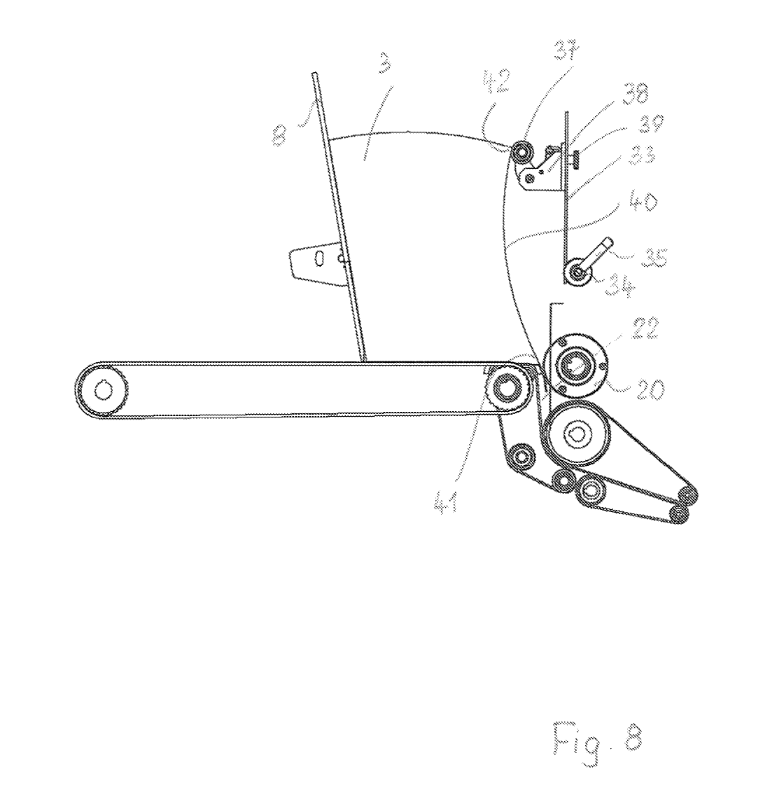

FIG. 8 shows the case that the products 40 forming the stack 3 are thicker at the upper edge 42 as well as at the lower edge 41, respectively. This causes the leading product 40 to be curved concavely. The support rollers 37 are positioned with pressure application at the upper edge of the stack 3. The carrier elements 38 are mounted on the carrier 33 such that the support rollers 37 are positioned substantially in the area above the carrier elements 38. The carrier 33 is located, in contrast to the embodiment of FIG. 7, in an approximately vertical position because as a result of the thicker upper product edge 42 the stack 3 at its topside has a greater thickness than in the embodiment according to FIG. 7. By means of the actuator shaft 34, the carrier 33 can be pivoted in a simple way into the desired position. By means of the actuating element 35, the actuator shaft 34 and thus the carrier 33 are clamped in the required position. The carrier elements 38 are clamped by means of the nuts 39 in the adjusted position.

The leading products 40 are secured by means of the support rollers 37 such that they cannot slide in uncontrolled fashion into the individualizing gap 22 but by means of the vacuum roller 20 are instead removed in a controlled fashion in sequence from the stack 3.

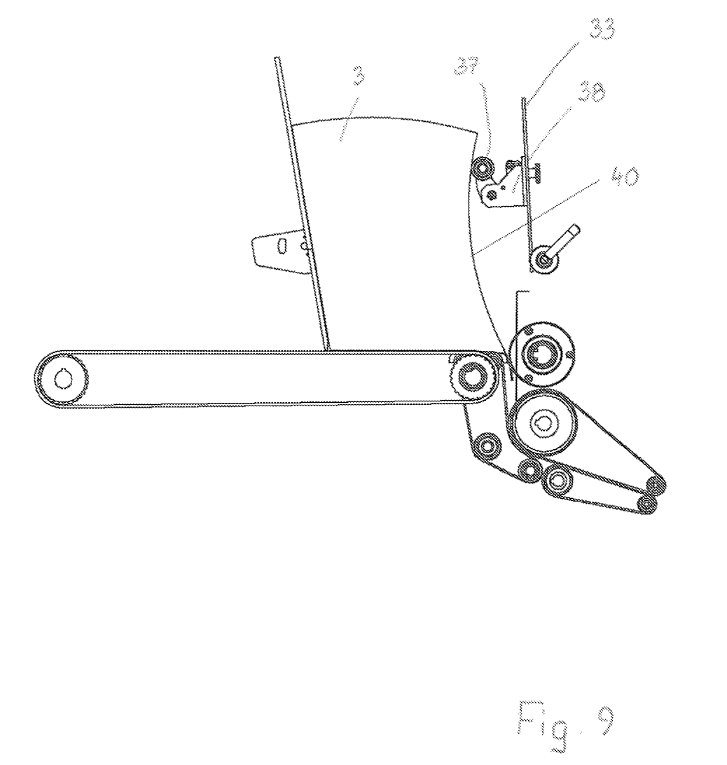

FIG. 9 shows that the support rollers 37 can also be positioned at a spacing from the topside of the stack 3 at its front side. This different positions of the support rollers 37 depend on the type of the product 40. Since the carrier elements 38 can be adjusted continuously along the length of the carrier 33, the support rollers 37 can be adjusted, depending on the product properties, in an optimal position.

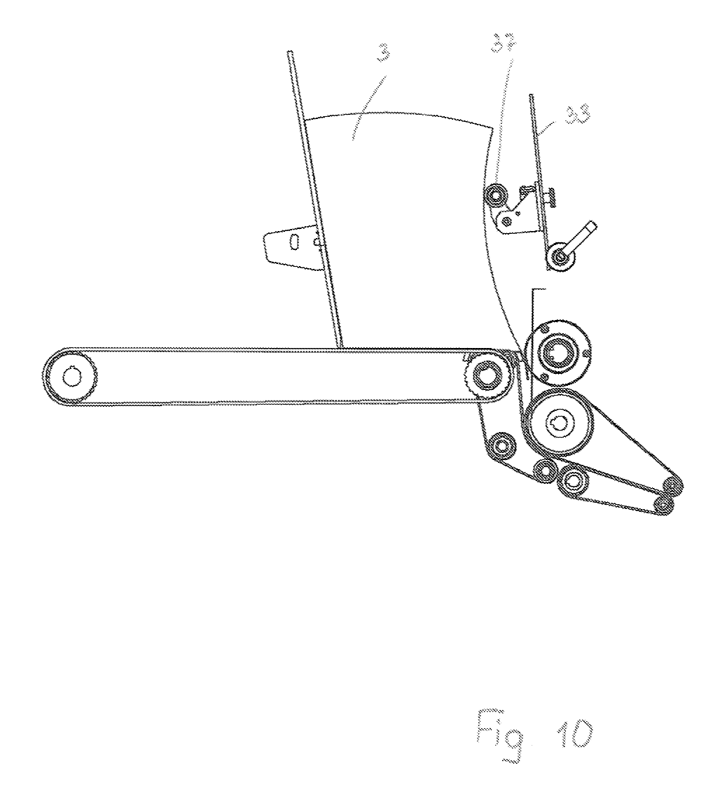

FIG. 10 shows a further position of the support rollers 37 relative to the product stack 3.

In the described situations the support rollers 37 are positioned on the stack 3 such that the areas of the products 40 above the support rollers 37 will not fold over and thereby possibly impair the removal of the products from the stack 3. When the products 40 are relatively stiff, the support rollers 37 can rest farther down on the end face of the stack 3 than in case of products that are comprised of less stiff material, for example, paper sheets and the like.

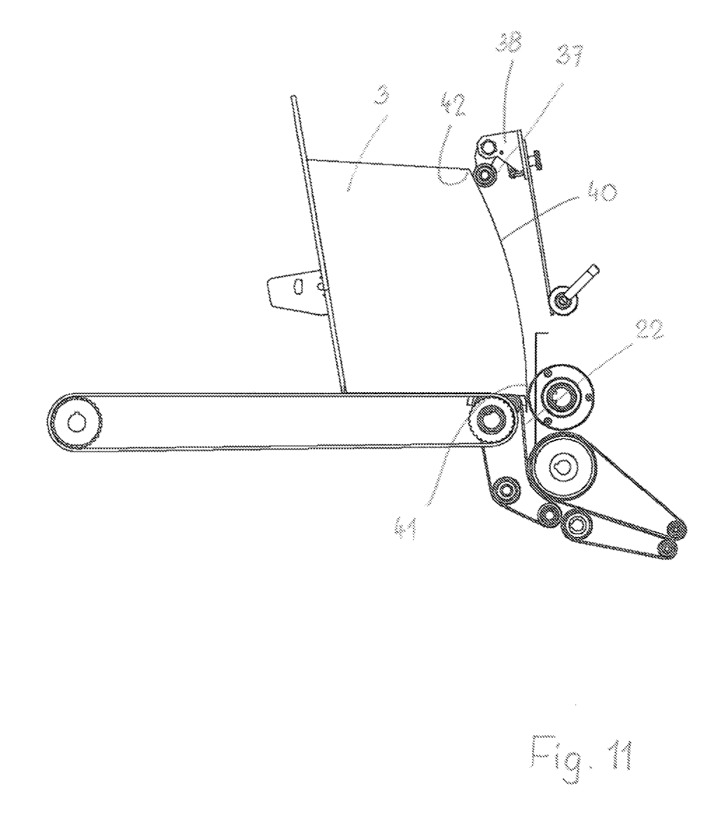

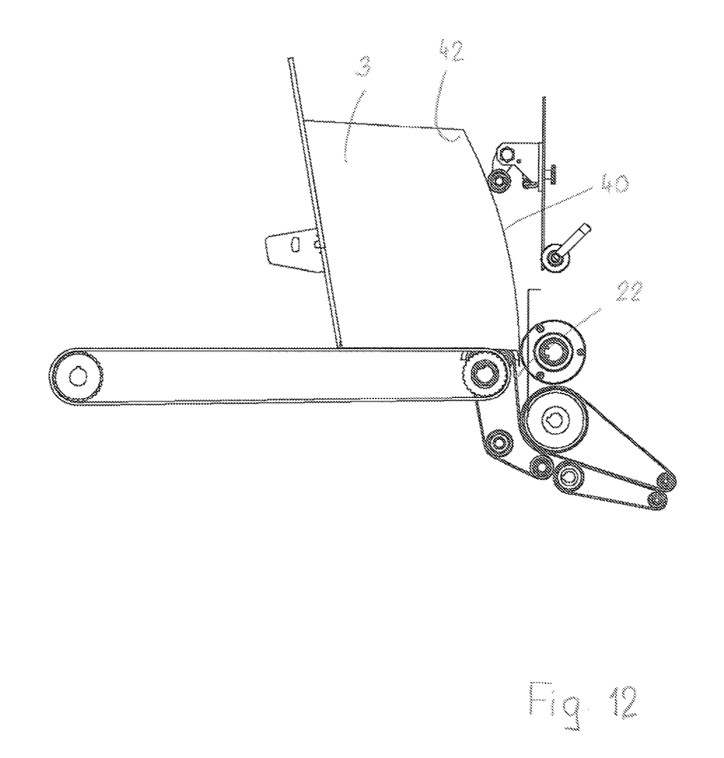

FIG. 11 and FIG. 12 show the situation where the stack 3 in the area between the lower and the upper product edges 41, 42 has a greater thickness than in the upper and lower edge areas. In this case it is also ensured that leading product 40 of the stack 3 cannot slide in an uncontrolled fashion into the individualizing gap 22. The support rollers 37 engage in the embodiment according to FIG. 11 the upper product edge 42; the support rollers 37 are located in the area below the carrier elements 38.

The support rollers, depending on the product properties, can also be positioned with pressure application at a spacing from the upper edge 42 on the end face of the stack 3. The leading product 40 is also secured reliably in this case so that it will not slide in uncontrolled fashion into the individualizing gap 22.

As shown in the various embodiments, by means of the support rollers 37 the stack 3 is secured such that the leading product 40 of the stack 3 cannot slide into the individualizing gap 22 but is engaged by the vacuum roller 20 in interaction with the transport belts 27 and is removed from the stack. Since the carrier elements 38 of the support rollers 37 in the direction of height of the stack 33 can be adjusted continuously and the carrier 33, in turn, by means of the actuator shaft 34 can be pivoted continuously, the support rollers 37, depending on the product properties, can be adjusted to assume an optimal position. In this way, the feeding unit can process a great variety of products. The products can be of thin or thick paper, plastic material, and the like. All of these products are reliably removed from the stack in sequence from the end face of the stack.

The gap width of the individualizing gap 22 can be adjusted also to the product properties or product type so that depending on the product thickness of the product the products are reliably removed from the end face of the stack 3.

The feeding unit is characterized by a simple configuration and construction. The support rollers 37 can be adjusted by the user of the feeding unit in a simple and comfortable way.

In the described embodiment the support rollers 37 as well as the actuator shaft 34 are manually adjusted. Instead of manual adjustment, it is, of course, also possible to provide a motor-driven adjustment. The adjustment can be done in particular automatically. The operator in such a case can carry out the optimal adjustments by electric adjustment, for example, by means of a rocker switch and can save the adjusted values to a memory. In this case, when subsequently orders with the same product are to be processed, the saved adjustments can be retrieved from the memory. The support rollers 37 and the actuator shaft 34 are then positioned automatically in the required position. This provides for a very efficient processing.

The specification incorporates by reference the entire disclosure of German priority document 10 2010 054 389.6 having a filing date of Dec. 6, 2010.

While specific embodiments of the invention have been shown and described in detail to illustrate the inventive principles, it will be understood that the invention may be embodied otherwise without departing from such principles.

What is claimed is:

1. A feeding unit for an inserting system, the feeding unit comprising:
a transport device;
at least one stack support for a product stack from which products are individually and in sequence removed from an end face of the stack in a downward direction and transported father by the transport device;
at least one support roller positioned at the end face of the stack in an area above the transport device and adjustable in a direction transverse to the end face of the stack and in a direction of height of the end face of the stack.

2. The feeding unit according to claim 1, further comprising at least one carrier wherein the at least one support roller is supported on the at least one carrier and adjustable in the direction of height on the at least one carrier.

3. The feeding unit according to claim 1, wherein the at least one carrier has at least one guide along which a carrier element of the at least one support roller is adjustable.

4. The feeding unit according to claim 3, wherein the guide is a slot through which the carrier element of the at least one support roller projects with a guide section on which an operating element is seated with which the support element is clamped in a selected position on the at least one carrier.

5. The feeding unit according to claim 2, wherein the at least one carrier is adjustable transversely to the end face of the stack.

6. The feeding unit according to claim 2, wherein the at least one carrier is pivotable transversely to the end face of the stack.

7. The feeding unit according to claim 6, comprising an actuator shaft wherein the at least one carrier is attached to the actuator shaft.

8. The feeding unit according to claim 7, wherein the at least one carrier has a lower edge that is attached to the actuator shaft.

9. The feeding unit according to claim 2, wherein the at least one carrier is a plate.

10. The feeding unit according to claim 1, wherein the products are individually removed through an individualizing gap having a gap width that is adjustable.
